(19) United States
(12) Patent Application Publication
(10) Pub. No.: US 2024/0319714 A1
(43) Pub. Date: Sep. 26, 2024

(54) APPARATUS AND METHOD FOR MANUFACTURING A DISPLAY APPARATUS

(71) Applicant: Samsung Display Co., Ltd., Yongin-si (KR)

(72) Inventor: Yonggu Kim, Yongin-si (KR)

(21) Appl. No.: 18/615,231

(22) Filed: Mar. 25, 2024

(30) Foreign Application Priority Data
Mar. 24, 2023 (KR) 10-2023-0038976
Jul. 13, 2023 (KR) 10-2023-0091348

(51) Int. Cl. G05B 19/4155

(52) U.S. Cl. CPC G05B 19/4155; G05B 2219/32015

(57) ABSTRACT

An apparatus for manufacturing a display apparatus and a method of manufacturing a display apparatus including collecting process data generated from a plurality of parts a plurality of processors during manufacture of a product, inputting the collected process data to a digital twin and then comparing, among the collected process data, first process data for the plurality of parts collected when a defect occurs in the product with second process data for the plurality of parts collected when a defect does not occur in the product and determining a monitoring part affecting the first process data and a defect of the product among the plurality of parts and a first data threshold of the monitoring part, collecting monitoring data sensed from the monitoring part and comparing the monitoring data with the first data threshold and determining whether the monitoring data and the first data threshold are different from each other.

This application claims priority to Korean Patent Application No. 10-2023-0038976, filed on Mar. 24, 2023, and Korean Patent Application No. 10-2023-0091348, filed on Jul. 13, 2023, and all the benefits accruing therefrom under 35 U.S.C. § 119, the contents of which in their entirety are herein incorporated by reference.

### BACKGROUND

### 1. Field

One or more embodiments relate to an apparatus and method, and more particularly, to an apparatus and method for manufacturing a display apparatus.

### 2. Description of the Related Art

Electronic apparatuses based on mobility have been widely used. Recently, in addition to small electronic apparatuses such as mobile phones, tablet personal computers (PCs) have been widely used as mobile electronic apparatuses.

Such mobile electronic apparatuses include a display apparatus to provide visual information such as images or videos to a user in order to support various functions. Recently, as other parts for driving a display apparatus have been miniaturized, the proportion of a display apparatus in an electronic apparatus has gradually increased and a structure capable of being bent from a flat state by a certain angle has also been developed.

### SUMMARY

In an embodiment, various apparatuses may be used to manufacture a display apparatus. In this case, defects may occur in the manufactured display apparatus due to the malfunction, damage, failure, or the like of the various apparatuses and/or parts of each of the apparatuses. In order to reduce the occurrence of defects in the display apparatus, maintenance and monitoring of each manufacturing apparatus and/or each part thereof may be a very important issue. One or more embodiments include an apparatus and method for manufacturing a display apparatus, which are capable of monitoring and simulating the damage, failure, or the like of each apparatus in a manufacturing process and/or each part thereof to determine a threshold thereof and preemptively manage the process of actual apparatuses such that the threshold is not reached.

Additional embodiments will be set forth in part in the description which follows and, in part, will be apparent from the description, or may be learned by practice of the presented embodiments.

According to one or more embodiments, an apparatus for manufacturing a display apparatus includes a first process line including a plurality of first processors configured to process a plurality of first processed products, wherein each of the plurality of first processors includes a plurality of first parts, a second process line including a plurality of second processors configured to process each of the plurality of first processed products processed by the first processor, into a second processed product, wherein each of the plurality of second processors includes a plurality of second parts, and a controller configured to receive process data generated from each of the plurality of first parts and each of the plurality of second parts and generate a work schedule of at least one of the first process line and the second process line based on the process data, wherein the controller is configured to select at least one of the plurality of first parts and the plurality of second parts affecting a defect of the second processed product as a monitoring part based on whether there is a defect in the second processed product, and when a defect occurs in the second processed product, to calculate a data threshold of the monitoring part, compare monitoring data of the monitoring part with the data threshold, and modify a work schedule of at least one of the first process line and the second process line.

In an embodiment, the controller may be further configured to simulate the modification of the work schedule of at least one of the first process line and the second process line in a digital twin.

In an embodiment, the controller may be further configured to calculate an action time necessary for repairing the monitoring part when the monitoring data of the monitoring part is greater than or equal to a certain percentage of the data threshold.

In an embodiment, the controller may be further configured to calculate a runnable time of the second processor that is different from the time the second processor is stopped during the action time.

In an embodiment, the controller may be further configured to compare the runnable time with the action time, and when the runnable time is greater than or equal to the action time, exclude the stopped second processor from the work schedule and perform the modification such that the second processor operates different from how the stopped second processor operates.

In an embodiment, the controller may be further configured to compare the runnable time with the action time and modify the work schedule of the first process line when the runnable time is less than the action time.

In an embodiment, the controller may be further configured to transmit, to a worker, an operation image of the monitoring part and at least one of the first processor and the second processor including the monitoring part implemented as a digital twin when the monitoring data of the monitoring part is greater than or equal to the data threshold and an operation image of the monitoring part and at least one of the first processor and the second processor including the monitoring part implemented as a digital twin when the monitoring data of the monitoring part is less than the data threshold.

In an embodiment, the certain percentage may be about 90%.

In an embodiment, the controller may include a simulator configured to perform a simulation.

According to one or more embodiments, a method of manufacturing a display apparatus includes collecting process data generated from a plurality of parts of each of a plurality of processors during the manufacture of a product, inputting the collected process data to a digital twin and then comparing, among the collected process data, first process data of each of the plurality of parts collected when a defect occurs in the product with second process data of each of the plurality of parts collected when a defect does not occur in the product and determining a monitoring part affecting the first process data and a defect of the product among the plurality of parts and a first data threshold of the monitoring part, collecting monitoring data sensed from the monitoring part, and comparing the monitoring data with the first data threshold and determining whether the monitoring data and the first data threshold are different from each other.

In the present embodiments, the method may further include stopping an operation of a processor including the monitoring part when the monitoring data exceeds a certain percentage of the first data threshold.

In an embodiment, the certain percentage may be about 90%.

In an embodiment, the method may further include calculating an action time for stopping the operation of the processor, including the monitoring part, in order to replace the monitoring part.

In an embodiment, the method may further include determining whether there is a runnable processor among the plurality of processors during the action time.

In an embodiment, the method may further include, when it is determined that there is a runnable processor, calculating a runnable time of the runnable processor in the digital twin.

In an embodiment, the method may further include running the runnable processor that is different from the processor in which the monitoring part is arranged, when the runnable time is greater than the action time.

In an embodiment, the method may further include stopping an operation of at least one of the plurality of processors when the runnable time is less than the action time.

In an embodiment, the plurality of processors may include a plurality of first processors configured to perform a first process, a storage for receiving and storing a first processed product processed by each of the plurality of first processors, and a plurality of second processors configured to generate a second processed product by performing a second process on one of the first processed products stored in the storage, and the method may further include controlling an operation of the first processor based on a filling rate of the storage when the runnable time is less than the action time.

In an embodiment, the method may further include comparing and displaying an image of the monitoring part in a state of the first data threshold and an image of the monitoring part in a state other than the state of the first data threshold.

In an embodiment, the method may further include generating a work schedule by comparing the monitoring data with the first data threshold.

Other aspects, features, and advantages other than those described above will become apparent from the accompanying drawings, the appended claims, and the detailed description.

In an embodiment, these general and particular aspects may be implemented by using systems, methods, computer programs, or any combinations of systems, methods, and computer programs.

### BRIEF DESCRIPTION OF THE DRAWINGS

The above and other aspects, features, and advantages of embodiments will be more apparent from the following description taken in conjunction with the accompanying drawings, in which:

FIG. 1 is a perspective view of a schematic block diagram illustrating a display apparatus manufacturing apparatus, according to an embodiment;

FIG. 2 is a schematic block diagram illustrating a controller of a display apparatus manufacturing apparatus, according to an embodiment;

FIG. 3 is a flowchart illustrating a control flow of the display apparatus manufacturing apparatus illustrated in FIGS. 1 and 2, according to an embodiment;

FIG. 4 is a flowchart illustrating a control flow for generating a second work schedule illustrated in FIG. 3, according to an embodiment;

FIG. 5 is a plan view schematically illustrating a display apparatus, according to an embodiment;

FIG. 6 is a cross-sectional view schematically illustrating a display apparatus manufactured by a display apparatus manufacturing method, according to an embodiment; and

FIG. 7 is a schematic equivalent circuit diagram of a pixel of a display panel, according to an embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the invention. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

The invention may include various embodiments and modifications, and particular embodiments thereof are illustrated in the drawings and will be described herein in detail. The effects and features of the invention and the accomplishing methods thereof will become apparent from the embodiments described below in detail with reference to the accompanying drawings. However, the disclosure is not limited to the embodiments described below and may be embodied in various modes.

Hereinafter, embodiments will be described in detail with reference to the accompanying drawings, and in the following description, like reference numerals will denote like elements and redundant descriptions thereof will be omitted.

It will be understood that although terms such as “first” and “second” may be used herein to describe various elements, these elements should not be limited by these terms and these terms are only used to distinguish one element from another element. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, the singular forms “a,” “an”, and “the” are intended to include the plural forms as well, unless the context clearly indicates otherwise.

It will be understood that terms such as “comprise,” “include,” and “have” as used herein specify the presence of stated features and/or elements, but do not preclude the presence and/or addition of one or more other features or elements.

It will be understood that when a layer, region, area, component, and/or element is referred to as being “on” another layer, region, area, component, and/or element, it may be “directly on” the other layer, region, area, component, and/or element or may be “indirectly on” the other layer, region, area, component, and/or element with one or more intervening layers, regions, areas, components, and/or elements therebetween.

Sizes of elements in the drawings may be exaggerated for convenience of description. In other words, because the sizes and shapes of components in the drawings are arbitrarily illustrated for convenience of description, the disclosure is not limited thereto.

As used herein, the x-axis, the y-axis, and the z-axis are not limited to three axes of the rectangular coordinate system and may be interpreted in a broader sense. For example, the x-axis, y-axis, and z-axis may be perpendicular to each other or may refer to different directions that are not perpendicular to each other.

When a certain embodiment may be implemented differently, a particular process order may be performed differently from the described order. For example, two processes described in succession may be performed substantially at the same time or may be performed in an order opposite to the described order.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

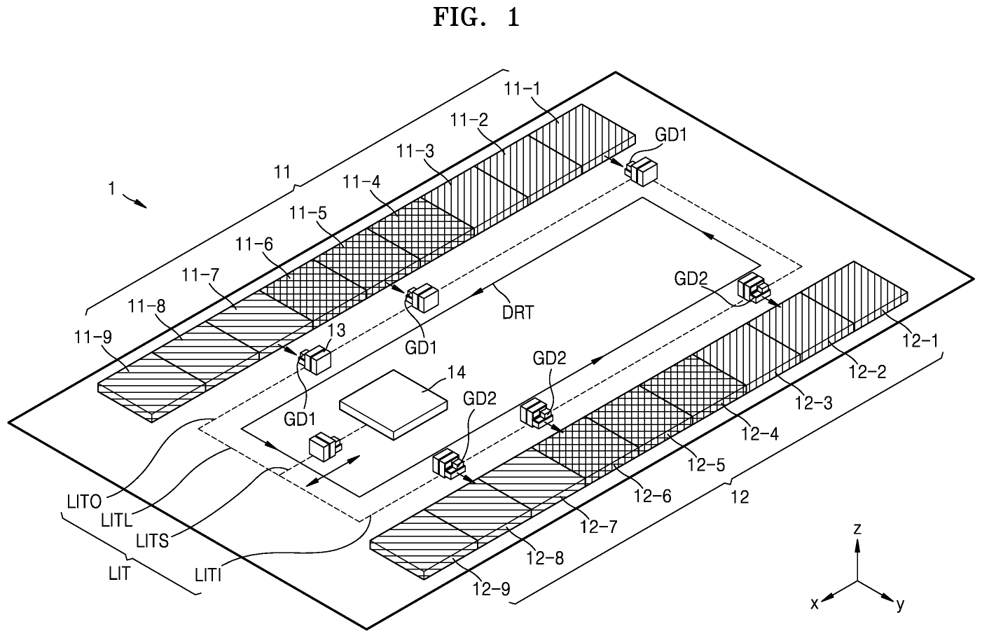

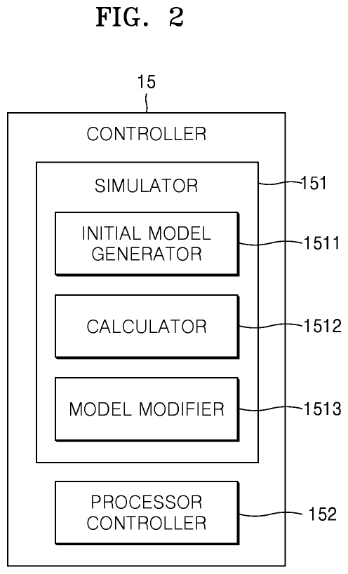

FIG. 1 is a perspective view schematically illustrating a display apparatus manufacturing apparatus according to an embodiment. FIG. 2 is a block diagram illustrating a controller of a display apparatus manufacturing apparatus, according to an embodiment.

In an embodiment and referring to FIGS. 1 and 2, a display apparatus manufacturing apparatus 1 may include a first process line 11, a second process line 12, a plurality of transporters 13, a storage 14, and a controller 15.

In an embodiment, the first process line 11 may include a plurality of first processors (not illustrated). The plurality of first processors may be sequentially arranged in a first direction (e.g., an x-axis direction).

In an embodiment, the plurality of first processors may primarily process a first processed product (or workpiece). In this case, each of the plurality of first processors may include a plurality of first parts. For example, the plurality of first parts may include various motors, frames, guides, and/or various sensors.

In an embodiment, the plurality of first processors may include a 1st-1 processor 11-1, a 1st-2 processor 11-2, . . . , a 1st-N processor (not illustrated). Here, N may be a natural number greater than or equal to 0. Hereinafter, for convenience of description, a case where the plurality of first processors include a 1st-1 processor 11-1, a 1st-2 processor 11-2, a 1st-3 processor 11-3, a 1st-4 processor 11-4, a 1st-5 processor 11-5, a 1st-6 processor 11-6, a 1st-7 processor 11-7, a 1st-8 processor 11-8, and a 1st-9 processor 11-9 will be mainly described in detail.

In an embodiment, each of the plurality of first processors may operate in any one of a run state, an idle state, and a down state. The run state may be a state in which a first processed product GD1 may be processed. The idle state may be a state in which the processor may not be temporarily run due to, for example, a temporary error. The down state may be a state in which the processor may not be continuously run.

In an embodiment, the second process line 12 may be arranged to be spaced apart from the first process line 11 in a second direction (e.g., a y-axis direction) intersecting the first direction (e.g., the x-axis direction). The second process line 12 may include a plurality of second processors (not illustrated). The plurality of second processors may be sequentially arranged in the first direction (e.g., the x-axis direction).

In an embodiment, each of the plurality of second processors may manufacture a second processed product by secondarily processing the first processed product. In this case, the second processed product may be a final product or an intermediate product for producing a final product.

In an embodiment, the plurality of second processors may include a 2nd-1 processor 12-1, a 2nd-2 processor 12-2, . . . , a 2nd-M processor (not illustrated). Here, M may be a natural number greater than or equal to 0. Hereinafter, for convenience of description, a case where the plurality of second processors includes a 2nd-1 processor 12-1, a 2nd-2 processor 12-2, a 2nd-3 processor 12-3, a 2-4 processor 12-4, a 2nd-5 processor 12-5, a 2nd-6 processor 12-6, a 2nd-7 processor 12-7, a 2nd-8 processor 12-8, and a 2nd-9 processor 12-9 will be mainly described in detail.

In an embodiment, tach of the plurality of second processors may operate in any one of a run state, an idle state, and a down state. The run state may be a state in which a second processed product GD2 may be processed. The idle state may be a state in which the processor may not be temporarily run due to, for example, a temporary error. The down state may be a state in which the processor may not be continuously run.

In an embodiment, the storage 14 may be arranged between the first process line 11 and the second process line 12 and may store the first processed product GD1. That is, the first processed product GD1 processed in at least one of the plurality of first processors may be input to the storage 14 or output from the storage 14.

In an embodiment, due to the limitation in the size and cost of the storage 14, a total storage capacity of the storage 14 may be limited. For example, the first processed product GD1 storable by the storage 14 may not exceed a designated value. Hereinafter, the ratio of the amount stored in the storage 14 to the total storage capacity of the storage 14 will be referred to as a filling rate. For example, when the number of first processed products GD1 storable by the storage 14 is 100 and the number of first processed products GD1 stored in the storage 14 is 30, the filling rate may be 30%.

In an embodiment, the transporter 13 may move along a transport path LIT arranged between the first process line 11 and the second process line 12 and may be provided in plurality. The plurality of transporters 13 may transport the first processed product GD1 from the first process line 11 to the second process line 12 or the storage 14. The plurality of transporters 13 may output the first processed product GD1 from the first process line 11, transport the same to the second process line 12, and then input the same to the second process line 12.

In an embodiment, the plurality of transporters 13 may circulate in a transport direction while moving along the transport path LIT. A plurality of transport paths LIT may include an output path LITO, an input path LITI, a connection path LITL, and a storage path LITS.

In an embodiment, the output path LITO may be a path through which the plurality of transporters 13 output the first processed product GD1 from the first process line 11. For example, the output path LITO may extend in the first direction (e.g., the x-axis direction) parallel to the first process line 11 and may be arranged to be adjacent to the first process line 11. While moving in the transport direction DRT along the output path LITO, the plurality of transporters 13 may stop adjacent to any one of the plurality of first processors and then output any one of the first processed products GD1.

In an embodiment, the input path LITI may be a path through which the plurality of transporters 13 input the first processed product GD1 to the second process line 12. For example, the input path LITI may extend in the first direction (e.g., the x-axis direction) parallel to the second process line 12 and may be arranged to be adjacent to the second process line 12. While moving in the transport direction DRT along the input path LITI, the plurality of transporters 13 may stop adjacent to any one of the plurality of second processors and then input any one of the first processed products GD1 to one of the plurality of second processors.

In an embodiment, the connection path LITL may connect the output path LITO with the input path LITI. The connection path LITL may be provided as two connection paths. The connection path LITL may have the second direction (e.g., the y-axis direction), and both ends of the connection path LITL may be respectively connected to one end of the output path LITO and one end of the input path LITI. The plurality of transporters 13 may circulate the output path LITO, the connection path LITL, the input path LITI, and the connection path LITL in the transport direction DRT.

In an embodiment, the planar shape of the transport path LIT may be tetragonal. Also, the transport direction DRT may be a counterclockwise direction when viewed from the top down (e.g., a direction rotating around the +Z axis). However, this is merely an example, and the transport path LIT and the transport direction DRT are not limited thereto.

In an embodiment, the storage path LITS may be a path through which the plurality of transporters 13 input the first processed product GD1 to the storage 14. The storage path LITS may be connected to the connection path LITL. The plurality of transporters 13 may output any one of the plurality of first processed products GD1 from the first process line 11 and then stop adjacent to the storage 14 while moving sequentially along the output path LITO, the connection path LITL, and the storage path LITS and then input any one of the plurality of first processed products GD1 to the storage 14 and then move sequentially along the storage path LITS, the connection path LITL, and the input path LITI.

In an embodiment, the controller 15 may control the first process line 11 and the second process line 12. The controller 15 may include a simulator 151 and a processor controller 152.

In an embodiment, the simulator 151 may generate or vary a work schedule of the first process line 11 and/or the second process line 12. In this embodiment, based on process data actually sensed or generated from each processor and/or each part, the simulator 151 may identify each processor and/or a part of each processor required to be replaced due to the failure of the first process line 11 and/or the second process line 12 and the damage, repair, and/or the like in each process line in a digital twin that is a virtual space, calculate a processing time for repairing each processor and/or the part, and determine a processor to replace a processor whose part is to be replaced or modify the work schedule of each process line to adjust the work speed or the like when there is no processor to replace the processor. Hereinafter, for convenience of description, a case where the repair of each processor and/or the repair of a part of the processor or the like occurs due to the failure of the process line, then the damage of each process line, the failure and damage of each processor, the repair and damage of the part, or the like will be mainly described in detail. Also, hereinafter, for convenience of description, the work schedule of the first process line 11 will be referred to as a second work schedule and the work schedule of the second process line 12 will be referred to as a first work schedule.

In an embodiment, the simulator 151 may determine a second processor and/or a second part required to be repaired or replaced among each of the plurality of second processors and/or a plurality of second parts of each of the plurality of second processors and, when the second processor in which the second part is arranged is stopped, modify the first work schedule by determining a second processor for replacement.

Also, in an embodiment, the simulator 151 may modify the second work schedule when the first work schedule is not modifiable. For example, the simulator 151 may simulate a final model for switching at least one of the plurality of first processors to a down state in a digital twin that is a virtual space, such that the filling rate is less than or equal to a first value.

In an embodiment, when the processing speed of the first process line 11 is higher than the processing speed of the second process line 12, the amount of first processed products GD1 stored in the storage 14 may increase and thus the filling rate may increase. When the filling rate is greater than the first value, the efficiency of the display apparatus manufacturing apparatus 1 may decrease. Thus, the first value may be a value for efficiently operating the display apparatus manufacturing apparatus 1. That is, the first value may be a suitable filling rate. For example, the first value may be about 80%. However, this is merely an example, and the first value is not limited thereto.

Thus, in an embodiment, the final model may be a model for determining which of the plurality of first processors is to be switched to a down state in a digital twin that is a virtual space, such that the filling rate is less than or equal to the first value that is a suitable filling rate.

In an embodiment, the simulator 151 may include an initial model generator 1511, a calculator 1512, and a model modifier 1513.

In an embodiment, the initial model generator 1511 may generate at least one initial work schedule among the first work schedule and the second work schedule. In this case, the initial work schedule may be a value input at the time of arranging the display apparatus manufacturing apparatus or a work schedule set according to a determined manual when it is initially run to manufacture the product.

Also, in an embodiment, the initial model generator 1511 may generate an initial model that is an initial second work schedule. In this case, the second work schedule may be an initial model for switching at least one of the plurality of first processors to a down state in the digital twin such that the filling rate is less than or equal to the first value. That is, the initial model may be the first model simulated by the simulator 151. For example, the initial model may be a model for switching the 1st-9 processor 11-9 to a down state.

In an embodiment, based on the collected second process data and defect data about a defect in the sensed second processed product GD2 and/or the final product, the calculator 1512 may determine the second processor and/or the second part generating the defect data as a monitoring target to be monitored and determine a data threshold of the monitoring target. That is, the calculator 1512 may also receive defect data about a defect in the second processed product GD2 and/or the final product. In this case, based on the defect data, the calculator 1512 may classify the second process data into 2nd-1 process data in the case where a defect occurs in the second processed product GD2 and/or the final product and 2nd-2 process data in the case where no defects occur in the second processed product GD2 and/or the final product. Accordingly, by comparing the 2nd-1 process data with the 2nd-2 process data, among the 2nd-1 process data, the calculator 1512 may select the 2nd-1 process data related to the defect in the second processed product GD2 and/or the final product. Also, through the above process, based on the data related to the defect in the second processed product GD2 and/or the final product among the 2nd-1 process data, the calculator 1512 may generate a first data threshold of the second processor and/or the second part and set the second processor and/or the second part in which the first data threshold occurs, as a monitoring target. Hereinafter, for convenience of description, a case where the calculator 1512 generates a data threshold of the second part and sets the second part as a monitoring part that is a monitoring target will be mainly described in detail.

In an embodiment, the first data threshold may be determined for each part. Also, the first data threshold for a part may be a value representing various factors of the part through regression analysis of the various factors of the part. For example, when the second part having the first data threshold is a motor, the failure of the motor or the malfunction of the motor may be determined based on at least one of a plurality of factors such as the speed of the motor, the current applied to the motor, and the torque generated by the motor. In this embodiment, because the plurality of factors should be considered comprehensively rather than individually, as for whether each factor has a certain level of correlation with the failure of the motor or the malfunction of the motor, a coefficient of the correlation between each factor and the failure of the motor may be calculated through regression analysis and then each factor may be multiplied by the calculated coefficient and then the sum thereof may be used as the second process data of the motor. The above may be implemented in the digital twin provided in the simulator 151.

In an embodiment, the first work schedule may be modified by determining whether the second processor malfunctions and/or whether a part of the second processor is to be repaired, based on the second process data currently transmitted from the plurality of second processors. That is, the model modifier 1513 may apply the second process data generated from the plurality of second processors until now to a simulation model of the digital twin that simulates the actual display apparatus manufacturing apparatus as it is.

In an embodiment, in the digital twin, the model modifier 1513 may compare the second process data actually collected with the calculated first data threshold. Particularly, the model modifier 1513 may compare the monitoring data of the monitoring part with the first data threshold. In this case, the model modifier 1513 may determine whether the collected monitoring data is greater than or equal to a certain percentage of the first data threshold (e.g., about 90% of the first data threshold). Also, the model modifier 1513 may repeatedly perform the above operation in the simulator 151 when the monitoring data is less than a certain percentage of the first data threshold. In an embodiment, when a defect occurs in the second processed product GD2 and/or the final product, the model modifier 1513 may continuously upgrade the first data threshold based on the re-calculated first data threshold. In this case, the first data threshold may be variable. Also, based on the first data threshold calculated as above, the model modifier 1513 may modify an initially set first process schedule when the monitoring data generated from the monitoring part exceeds a certain percentage of the first data threshold.

In an embodiment, the model modifier 1513 may switch the second processor including the monitoring part having the monitoring data greater than or equal to a certain percentage of the first data threshold to a down state and then determine whether another second processor is available. For example, when there is a monitoring part having the monitoring data greater than or equal to the first data threshold in the 2nd-8 processor 12-8, the model modifier 1513 may switch the 2nd-8 processor 12-8 to a down state in the digital twin. Also, the model modifier 1513 may calculate a processing time necessary for repairing the 2nd-8 processor 12-8 (e.g., replacement of a monitoring part of the 2nd-8 processor 12-8) and determine whether there is a second processor that is runnable but is not run, among the 2nd-1 processor 12-1, the 2nd-2 processor 12-2, the 2nd-3 processor 12-3, the 2nd-4 processor 12-4, the 2nd-5 processor 12-5, the 2nd-6 processor 12-6, the 2nd-7 processor 12-7, and the 2nd-9 processors 12-9 other than the 2nd-8 processor 12-8. Based on this, the model modifier 1513 may calculate a runnable time when the second processor is run. The model modifier 1513 may actually receive monitoring data of each monitoring part of the second processor and compare each monitoring data with the first data threshold. In this case, the time for the current monitoring data to reach the first data threshold may be calculated through a function preset in the calculator 1512.

Alternatively, in an embodiment, the time at which the current monitoring data reaches the first data threshold may be stored in the calculator 1512 in the form of a table with respect to the current second process data. When the runnable time is greater than the processing time, the model modifier 1513 may modify the first process schedule to stop an operation of the 2nd-8 processor 12-8 and operate a second processor that is runnable but is not run, among the 2nd-1 processor 12-1, the 2nd-2 processor 12-2, the 2nd-3 processor 12-3, the 2nd-4 processor 12-4, the 2nd-5 processor 12-5, the 2nd-6 processor 12-6, the 2nd-7 processor 12-7, and the 2nd-9 processor 12-9 other than the 2nd-8 processor 12-8. When there is a second processor for replacement, the model modifier 1513 may generate a new first process schedule and transmit the same to the processor controller 152. On the other hand, when there is no second processor for replacement, a first process schedule that is modified to stop an operation of the 2nd-8 processors 12-8 in the first process schedule may be transmitted to the processor controller 152. Thereafter, a second process schedule may be modified.

In an embodiment, in the case of the second process schedule, in the digital twin, according to the initial model, the calculator 1512 may calculate a filling rate in the digital twin after controlling the first process line 11 during a first time. For example, the first time may be 1 hour. However, this is merely an example, and the first time is not limited thereto.

In an embodiment, when the filling rate in the digital twin according to the initial model is less than or equal to the first value, the initial model may be the final model.

On the other hand, in an embodiment, when the filling rate in the digital twin according to the initial model exceeds the first value, the model modifier 1513 may modify the initial model into a first model.

In an embodiment, in comparison with the initial model, the first model may be a model for additionally switching any one first processor with the highest progress rate among the plurality of first processors in a run state to a down state. Here, the progress rate may be the ratio of the current number of processes to the target number of processes for a designated time. For example, when the target number of processes per day of the 1st-9 processor 11-9 for the first processed product is 100 and the number of first parts processed by the 1st-9 processor 11-9 until now is 90, the progress rate of the 1st-9 processor 11-9 may be about 90%.

For example, in an embodiment, when the filling rate in the digital twin according to the initial model for switching the 1st-9 processor 11-9 to a down state exceeds the first value, the model modifier 1513 may modify the initial model into the first model for additionally switching the 1st-9 processor 11-9 to a down state.

In an embodiment, in the digital twin, according to the first model, the calculator 1512 may calculate a filling rate in the digital twin after controlling the first process line 11 during the first time.

In an embodiment, when the filling rate in the digital twin according to the first model is less than or equal to the first value, the first model may be the final model.

On the other hand, in an embodiment, when the filling rate in the digital twin according to the first model exceeds the first value, the model modifier 1513 may modify the first model into a second model.

In an embodiment, in comparison with the first model, the second model may be a model for additionally switching any one first processor with the highest progress rate among the plurality of first processors in a run state to a down state.

In an embodiment, in the digital twin, according to the second model, the calculator 1512 may calculate a filling rate in the digital twin after controlling the first process line 11 during the first time.

In an embodiment, when the filling rate in the digital twin according to the second model is less than or equal to the first value, the second model may be the final model.

On the other hand, in an embodiment, when the filling rate in the digital twin according to the second model exceeds the first value, the above may be repeated.

In an embodiment, as a result, the filling rate in the digital twin according to the final model may be less than or equal to the first value.

In an embodiment, the processor controller 152 may control at least one of the first process line 11 and the second process line 12 according to the final model. That is, the processor controller 152 may control at least one of the first process line 11 and the second process line 12 according to the final model in the real world, not in the digital twin that is a virtual space. For example, the processor controller 152 may control at least one of the first process line 11 and the second process line 12 based on the modified first process schedule and second process schedule described above. In the embodiment of controlling the display apparatus manufacturing apparatus based on the second process schedule, the processor controller 152 may calculate the filling rate in real time after controlling the first process line 11 according to the final model.

In an embodiment, when the calculated filling rate satisfies a first condition, the processor controller 152 may switch the entire first process line 11 to a down state.

In an embodiment, the first condition may be a condition exceeding a second value. The second value may be a value close to 100% that is a limit filling rate of the storage 14. That is, the second value may be higher than the first value. For example, the second value may be about 90%. Thus, when the calculated filling rate exceeds the second value, the processor controller 152 may switch the entire first process line 11 to a down state, thus preventing an issue caused by failing to no longer store the first processed product GD1 because the filling rate reaches 100%.

In an embodiment, the first condition may be a condition in which the first value is exceeded after the first time has elapsed after the processor controller 152 controls the first process line 11 according to the final model. Thus, when the filling rate still exceeds the first value even after the first time has elapsed, the processor controller 152 may switch the entire first process line 11 to a down state to efficiently operate the display apparatus manufacturing apparatus 1.

In an embodiment, when the calculated filling rate satisfies a second condition, the processor controller 152 may continue to control the first process line 11 according to the final model.

In an embodiment, the second condition may be a condition other than the first condition. For example, the second condition may be a condition less than or equal to the second value. Also, the second condition may be a condition in which it is less than or equal to the first value after the first time has elapsed after the processor controller 152 controls the first process line 11 according to the final model.

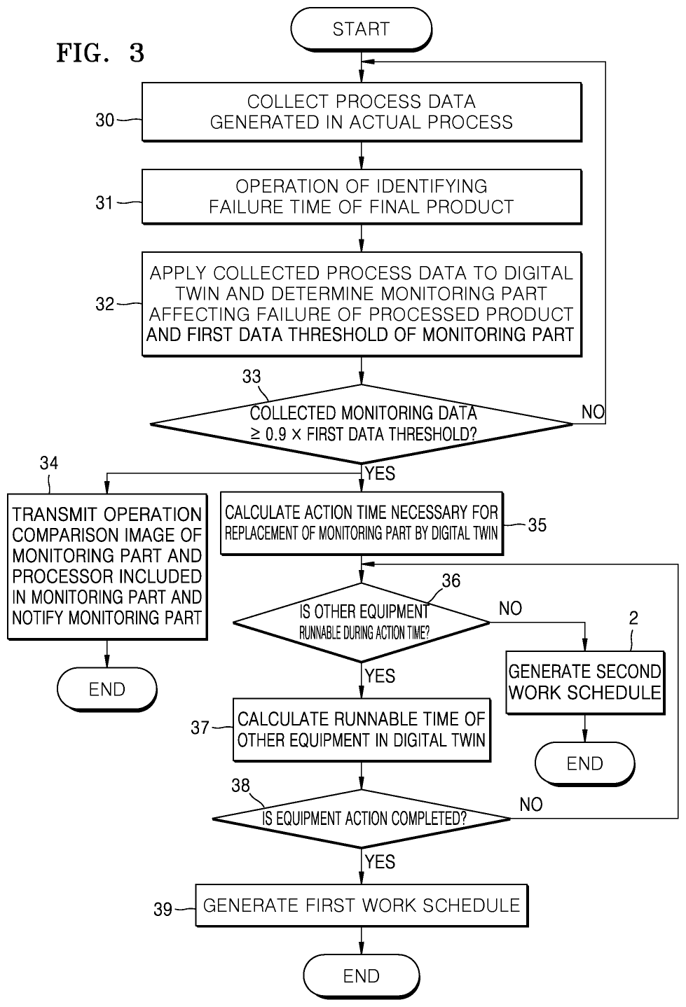

FIG. 3 is a flowchart schematically illustrating a control flow of the display apparatus manufacturing apparatus 1 illustrated in FIGS. 1 and 2, according to an embodiment. Hereinafter, like reference numerals as those in FIGS. 1 and 2 will denote like members.

Referring to FIG. 3, in an embodiment, the display apparatus manufacturing apparatus 1 may perform a process according to a preset initial work schedule. In this embodiment, initially, the simulator 151 may generate an initial work schedule based on initial data of the display apparatus manufacturing apparatus 1 in a digital twin environment.

In an embodiment, when the display apparatus manufacturing apparatus 1 operates, at least one of the first processor and the second processor may generate various process data. The process data described above may be transmitted to the simulator 151. The simulator 151 may generate a work schedule of the first process line 11 and/or the second process line 12 in a digital twin based on the above process data.

Particularly, in an embodiment, the process data generated by the first processor and the second processor may be transmitted to the calculator 1512. Also, the second processed product GD2 and/or the final product may be inspected and information about whether the second processed product GD2 is defective and/or whether the final product is defective may be transmitted to the calculator 1512 (operation 30).

In an embodiment, the calculator 1512 may identify a defect time when a defect in the second processed product GD2 occurs and/or a defect in the final product occurs (operation 31). In this embodiment, among the second process data, the calculator 1512 may compare the 2nd-1 process data generated at the defect time with the 2nd-2 process data generated at the time when a defect does not occur. In this embodiment, the calculator 1512 may determine the 2nd-1 process data as the first data threshold. Also, when the 2nd-1 process data becomes the first data threshold, the calculator 1512 may determine at least one of the second processor and/or the plurality of parts of the second processor having this value as a monitoring target. Hereinafter, for convenience of description, an embodiment where the monitoring target is a monitoring part that is one of the plurality of parts of the second processor will be mainly described in detail (operation 32).

Moreover, in an embodiment, new second process data generated in the display apparatus manufacturing apparatus 1 after lapse of a certain period of time may be input into the simulator 151. In this embodiment, among the new second process data, the model modifier 1513 may compare monitoring data of a monitoring part with the first data threshold (operation 33). In this embodiment, when the monitored data is less than a certain percentage of the first data threshold (e.g., about 90% of the first data threshold), it may be determined that an initial first work schedule is normal. In this embodiment, the model modifier 1513 may determine the initial first work schedule as a final first work schedule and may transmit the final first work schedule to the display apparatus manufacturing apparatus.

In an embodiment, even when the monitoring data is less than a certain percentage of the first data threshold (e.g., about 90% of the first data threshold), the calculator 1512 may identify whether a defect in the second processed product GD2 occurs and/or a defect in the final product occurs. In this embodiment, when a defect in the second processed product GD2 occurs and/or a defect in the final product occurs, the calculator 1512 may modify the 2nd-1 process data, which is the monitoring data of the monitoring part at the time when a defect occurs, from the existing first data threshold to a new first data threshold. Also, when a monitoring part is added at the time when a defect occurs, the calculator 1512 may add a new monitoring part and a first data threshold of the monitoring part.

In the above embodiment, when the newly updated monitoring data of the monitoring part is determined to be greater than or equal to a certain percentage of the first data threshold, the calculator 1512 may use the digital twin to calculate an action time required for work such as replacement or repair of the monitoring part having the monitoring data greater than or equal to a certain percentage of the first data threshold (operation 35). Also, the simulator 151 may transmit, to an outside worker, an image of a first operation of the second processor included in the monitoring part and/or the monitoring part at the time when a defect occurs in the second processed product GD2 and/or the final product and a second operation of the second processor included in the monitoring part and/or the monitoring part at the time when a defect does not occur in the second processed product GD2 and/or the final product. Also, the simulator 151 may calculate the current state of the monitoring part, the time remaining until the replacement or repair of the monitoring part, and/or the like and transmit the calculation result to the external worker (operation 34). Although not illustrated, this work may be transmitted to the worker after the operation of identifying the defective time or the operation of calculating the first data threshold described above.

In an embodiment, when the above process is completed, the model modifier 1513 may identify, among the plurality of second processors, a second processor that is currently set not to perform the process but is capable of performing the process. For example, when the 2nd-8 processor 12-8 among the 2nd-1 processor 12-1, the 2nd-2 processor 12-2, the 2nd-3 processor 12-3, the 2nd-4 processor 12-4, the 2nd-5 processor 12-5, the 2nd-6 processor 12-6, the 2nd-7 processor 12-7, the 2nd-8 processor 12-8, and the 2nd-9 processor 12-9 should be repaired or at least one of the second parts of the 2nd-8 processor 12-8 should be replaced, the 2nd-8 processor 12-8 should wait by failing to be put into the process. In this embodiment, the model modifier 1513 may identify a second processor capable of performing the process among the 2nd-1 processor 12-1, the 2nd-2 processor 12-2, the 2-3 processor 12-3, the 2nd-4 processor 12-4, the 2nd-5 processor 12-5, the 2nd-6 processor 12-6, the 2nd-7 processor 12-7, and the 2nd-9 processor 12-9 in replacement of the 2nd-8 processor 12-8. Hereinafter, for convenience of description, a case where the 2nd-9 processor 12-9 is run instead of the 2nd-8 processor 12-8 will be mainly described in detail (operation 36).

In an embodiment, when the 2nd-9 processor 12-9 replaces the 2nd-8 processor 12-8, the calculator 1512 may calculate a runnable time of the 2nd-9 processor 12-9 in which the 2nd-9 processor 12-9 is runnable (operation 37). In this embodiment, the calculator 1512 may calculate the runnable time of the 2nd-9 processor 12-9 by comparing the second process data of the monitoring part of the 2nd-9 processor 12-9 with the first data threshold. The model modifier 1513 may compare the runnable time of the 2nd-9 processor 12-9 with the action time of the 2nd-8 processor 12-8 (operation 38). In this embodiment, when the runnable time of the 2nd-9 processor 12-9 is greater than or equal to the action time of the 2nd-8 processor 12-8, the model modifier 1513 may determine to input the 2nd-9 processor 12-9. The model modifier 1513 may exclude the 2nd-8 processor 12-8 from the initial first work schedule and generate a new first work schedule such that the 2nd-9 processor 12-9 is used in place of the 2nd-8 processor 12-8 (operation 39). The model modifier 1513 may transmit a new second work schedule to the processor controller 152. Thereafter, the processor controller 152 may control the display apparatus manufacturing apparatus 1 according to the new second work schedule.

On the other hand, in an embodiment, when it is determined that the runnable time of the 2nd-9 processor 12-9 is less than the action time of the 2nd-8 processor 12-8, the model modifier 1513 may again repeat the above process by identifying whether one of the second processors other than the 2nd-9 processor 12-9 and the 2nd-8 processor 12-8 is runnable.

In an embodiment, through the above work, the plurality of second processors arranged in the second process line 12 may be efficiently operated. Also, because a second processor in which a problem may occur among the plurality of second processors may be identified, the worker may preemptively manage the second process line 12. Also, by saving the time taken to repair the second process line 12, the product production time and cost may be controlled.

In an embodiment, in the above process, when there is no second processor to replace the 2nd-8 processor 12-8 among the plurality of second processors, the model modifier 1513 may generate a new second work schedule (operation 2). This will be described below in detail.

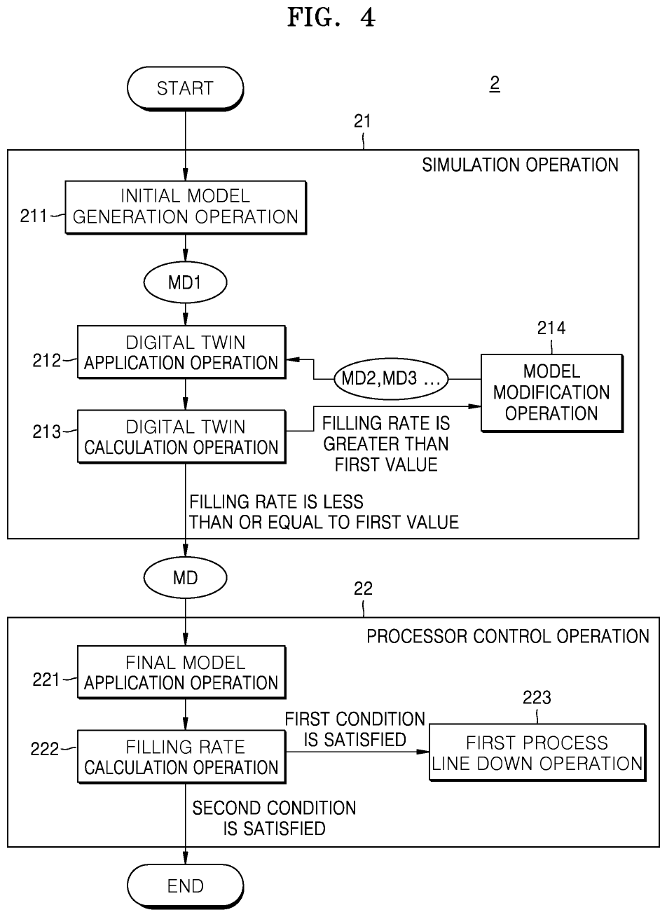

FIG. 4 is a flowchart illustrating a control flow for generating the second work schedule illustrated in FIG. 3, according to an embodiment.

In an embodiment and referring to FIG. 4, a second work schedule generation operation 2 may be an operation in which the controller 15 (see FIG. 2) controls the first process line 11 (see FIG. 1). The second work schedule generation operation 2 may include a simulation operation 21 and a processor control operation 22.

In an embodiment, the simulation operation 21 may be an operation in which the simulator 151 (see FIG. 2) simulates a final model MD for switching at least one of the plurality of first processors to a down state in the digital twin such that the filling rate is less than or equal to the first value. The simulation operation 21 may include an initial model generation operation 211, a digital twin application operation 212, and a digital twin calculation operation 213.

In an embodiment, the initial model generation operation 211 may be an operation in which the initial model generator 1511 (see FIG. 2) generates an initial model MD1 for switching at least one of the first processors or a plurality of 1st-1 processors 11-1 to a down state in the digital twin such that the filling rate is less than or equal to the first value.

In an embodiment, the digital twin application operation 212 may include an operation in which the calculator 1512 (see FIG. 2) controls the first process line 11 (see FIG. 1) according to the initial model MD1 in the digital twin.

In an embodiment, the digital twin calculation operation 213 may include an operation in which the calculator 1512 (see FIG. 2) calculates the filling rate in the digital twin after the first time has elapsed from the time when the digital twin application operation 212 starts according to the initial model MD1.

In an embodiment, when the filling rate in the digital twin according to the initial model MD1 is less than or equal to the first value, the initial model MD1 may be the final model MD.

On the other hand, in an embodiment, when the filling rate in the digital twin according to the initial model MD1 calculated in the digital twin calculation operation 213 exceeds the first value, a model modification operation 214 may include an operation in which the model modifier 1513 (see FIG. 2) modifies the initial model MD1 into a first model MD2.

In an embodiment, the digital twin application operation 212 may further include an operation in which the calculator 1512 (see FIG. 2) controls the first process line 11 (see FIG. 1) according to the first model MD2 in the digital twin.

In an embodiment, the digital twin calculation operation 213 may further include an operation in which the calculator 1512 (see FIG. 2) calculates the filling rate in the digital twin after the first time has elapsed from the time when the digital twin application operation 212 starts according to the first model MD2.

In an embodiment, when the filling rate in the digital twin according to the first model MD2 is less than or equal to the first value, the first model MD2 may be the final model MD.

On the other hand, in an embodiment, when the filling rate in the digital twin according to the first model MD2 calculated in the digital twin calculation operation 213 exceeds the first value, the model modification operation 214 may further include an operation in which the model modifier 1513 (see FIG. 2) modifies the first model MD2 into a second model MD3.

In an embodiment, the digital twin application operation 212 may further include an operation in which the calculator 1512 (see FIG. 2) controls the first process line 11 (see FIG. 1) according to the second model MD3 in the digital twin.

In an embodiment, the digital twin calculation operation 213 may further include an operation in which the calculator 1512 (see FIG. 2) calculates the filling rate in the digital twin after the first time has elapsed from the time when the digital twin application operation 212 starts according to the second model MD3.

In an embodiment, when the filling rate in the digital twin according to the second model MD3 is less than or equal to the first value, the second model MD3 may be the final model MD.

On the other hand, in an embodiment, when the filling rate in the digital twin according to the second model MD3 exceeds the first value, the above may be repeated.

As a result, in an embodiment, the filling rate in the digital twin according to the final model MD may be less than or equal to the first value.

In an embodiment, the processor control operation 22 may include a final model application operation 221, a filling rate calculation operation 222, and a first process line down operation 223.

In an embodiment, the final model application operation 221 may be an operation in which the processor controller 152 (see FIG. 2) controls the first process line 11 (see FIG. 1) according to the final model MD.

In an embodiment, the filling rate calculation operation 222 may be an operation in which the processor controller 152 (see FIG. 2) calculates the filling rate after the final model application operation 221.

In an embodiment, the first process line down operation 223 may be an operation in which the processor controller 152 (see FIG. 2) switches the entire first process line 11 (see FIG. 1) to a down state when the filling rate calculated in the filling rate calculation operation 222 satisfies the first condition. The first condition may be a condition exceeding the second value. Also, the first condition may be a condition exceeding the first value after the first time elapses after the processor controller 152 (see FIG. 2) controls the first process line 11 (see FIG. 1) according to the final model MD.

In an embodiment, after the first process line down operation 223, when the filling rate calculated by the processor controller 152 (see FIG. 2) decreases below the first value, the simulation operation 21 described above may be restarted.

In an embodiment, when the calculated filling rate satisfies the second condition, the processor controller 152 (see FIG. 2) may continue to control the first process line 11 according to the final model.

In an embodiment, the second condition may be a condition other than the first condition. For example, the second condition may be a condition less than or equal to the second value. Also, the second condition may be a condition less than or equal to the first value after the first time elapses after the processor controller 152 (see FIG. 2) controls the first process line 11 (see FIG. 1) according to the final model MD.

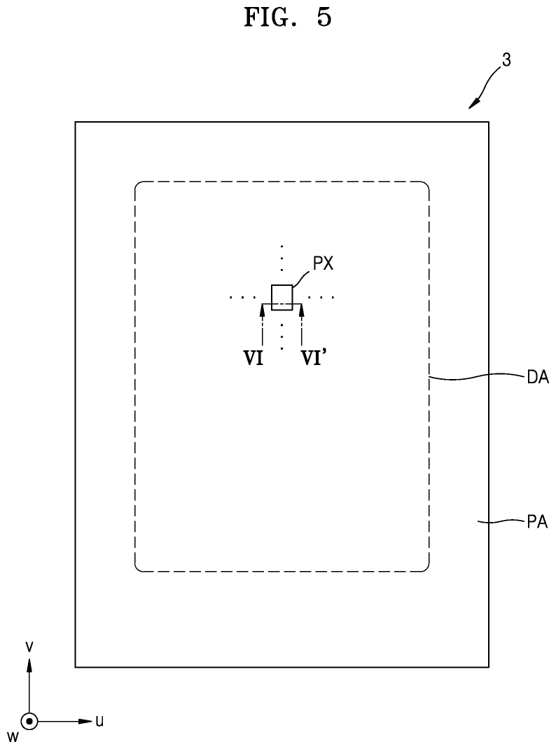

FIG. 5 is a plan view schematically illustrating a display apparatus, according to an embodiment.

In an embodiment and referring to FIG. 5, a display apparatus 3 may include a display area DA and a peripheral area PA located outside the display area DA. The display apparatus 3 may provide an image through an array of a plurality of pixels PX two-dimensionally arranged in the display area DA.

In an embodiment, the peripheral area PA may be an area not providing an image and may entirely or partially surround the display area DA. A driver or the like for providing an electrical signal or power to a pixel circuit corresponding to each of the pixels PX may be arranged in the peripheral area PA. The peripheral area PA may include a pad that is an area to which an electronic device, a printed circuit board, or the like may be electrically connected.

Hereinafter, an embodiment of the display apparatus 3 will be described as including an organic light emitting diode OLED as a light emitting element. However, the display apparatus 3 of the disclosure is not limited thereto. In another embodiment, the display apparatus 3 may include a light emitting display apparatus including an inorganic light emitting diode, that is, an inorganic light emitting display apparatus. The inorganic light emitting diode may include a PN diode including inorganic semiconductor-based materials. When a voltage is applied to the PN junction diode in a forward direction, holes and electrons may be injected thereinto and energy generated by recombination of the holes and electrons may be converted into light energy to emit light of a certain color. The inorganic light emitting diode described above may have a width of several to several hundred micrometers, and in some embodiments, the inorganic light emitting diode may be referred to as a micro LED. In another embodiment, the display apparatus 3 may include a quantum dot light emitting display apparatus.

Moreover, in an embodiment, the display apparatus 3 may be used as a display screen of various products such as televisions, notebook computers, monitors, billboards, and Internet of Things (IoT) apparatuses as well as portable electronic apparatuses such as mobile phones, smart phones, tablet personal computers (PCs), mobile communication terminals, electronic notebooks, electronic books, portable multimedia players (PMPs), navigation, and/or Ultra Mobile PCs (UMPCs). Also, the display apparatus 3 according to an embodiment may be used in wearable devices such as smart watches, watch phones, glasses-type displays, and/or head-mounted displays (HMDs). Also, the electronic apparatus 3 according to an embodiment may be used as a center information display (CID) arranged at a vehicle's instrument panel or a vehicle's center fascia or dashboard, a room mirror display replacing a vehicle's side mirror, and/or a display screen arranged at a rear side of a vehicle's front seat as entertainment for a vehicle's rear seat.

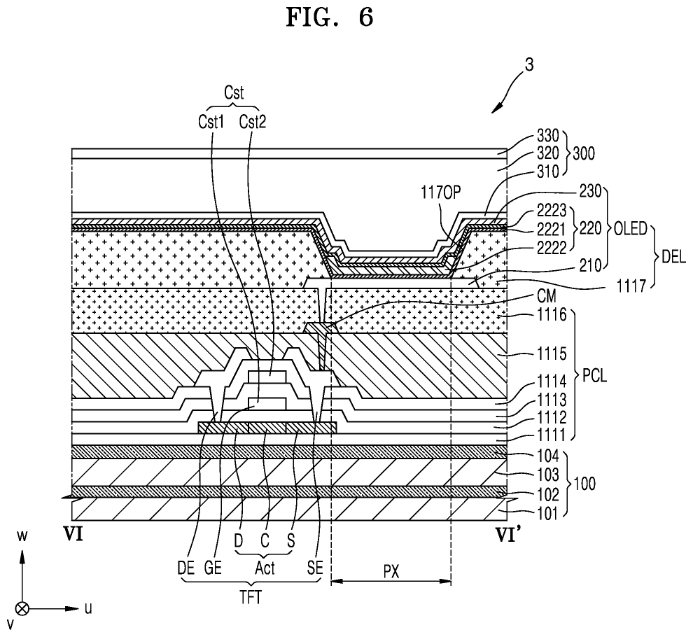

FIG. 6 is a cross-sectional view schematically illustrating a display apparatus manufactured by a display apparatus manufacturing method, according to an embodiment. FIG. 6 may correspond to a cross-section of the display apparatus 3 taken along line VI-VI′ of FIG. 5, according to an embodiment.

In an embodiment and referring to FIG. 6, the display apparatus 3 may include a stack structure of a substrate 100, a pixel circuit layer PCL, a display element layer DEL, and an encapsulation layer 300.

In an embodiment, the substrate 100 may have a multilayer structure including a base layer including a polymer resin and an inorganic layer. For example, the substrate 100 may include a base layer including a polymer resin and a barrier layer of an inorganic insulating layer. For example, the substrate 100 may include a first base layer 101, a first barrier layer 102, a second base layer 103, and a second barrier layer 104 that are sequentially stacked. The first base layer 101 and the second base layer 103 may include polyimide (PI), polyethersulphone (PES), polyarylate, polyetherimide (PEI), polyethylene naphthalate (PEN), polyethylene terephthalate (PET), polyphenylene sulfide (PPS), polycarbonate, cellulose triacetate (TAC), and/or cellulose acetate propionate (CAP). The first barrier layer 102 and the second barrier layer 104 may include an inorganic insulating material such as silicon oxide, silicon oxynitride, and/or silicon nitride. The substrate 100 may be flexible.

In an embodiment, the pixel circuit layer PCL may be disposed over the substrate 100. FIG. 6 illustrates that the pixel circuit layer PCL includes a thin film transistor TFT, and a buffer layer 1111, a first gate insulating layer 1112, a second gate insulating layer 1113, an interlayer insulating layer 1114, a first planarization insulating layer 1115, and a second planarization insulating layer 1116 that are disposed under and/or over the elements of the thin film transistor TFT.

In an embodiment, the buffer layer 1111 may reduce or block the penetration of foreign materials, moisture, or external air from under the substrate 100 and may provide a flat surface over the substrate 100. The buffer layer 1111 may include an inorganic insulating material such as silicon oxide, silicon oxynitride, and/or silicon nitride and may be formed in a single-layer or multiple-layer structure including the above material.

In an embodiment, the thin film transistor TFT over the buffer layer 1111 may include a semiconductor layer Act, and the semiconductor layer Act may include polysilicon (poly-Si). Alternatively, the semiconductor layer Act may include amorphous silicon (a-Si), may include an oxide semiconductor, or may include an organic semiconductor or the like. The semiconductor layer Act may include a channel area C and a source area S and a drain area D respectively arranged on both sides of the channel area C. A gate electrode GE may overlap the channel area C.

In an embodiment, the gate electrode GE may include a low-resistance metal material. The gate electrode GE may include a conductive material including molybdenum (Mo), aluminum (Al), copper (Cu), titanium (Ti), or the like and may include a single layer or multiple layers including the above material.

In an embodiment, the first gate insulating layer 1112 between the semiconductor layer Act and the gate electrode GE may include an inorganic insulating material such as silicon oxide (SiO₂), silicon nitride (SiNₓ), silicon oxynitride (SiON), aluminum oxide (Al₂O₃), titanium oxide (TiO₂), tantalum oxide (Ta₂O₅), and/or hafnium oxide (HfO₂), or zinc oxide (ZnOₓ). The zinc oxide (ZnOₓ) may include zinc oxide (ZnO) and/or zinc peroxide (ZnO₂).

In an embodiment, the second gate insulating layer 1113 may be provided to cover the gate electrode GE. Like the first gate insulating layer 1112, the second gate insulating layer 1113 may include an inorganic insulating material such as silicon oxide (SiO₂), silicon nitride (SiNₓ), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). The zinc oxide (ZnOₓ) may include zinc oxide (ZnO) and/or zinc peroxide (ZnO₂).

In an embodiment, an upper electrode Cst2 of a storage capacitor Cst may be disposed over the second gate insulating layer 1113. The upper electrode Cst2 may overlap the gate electrode GE thereunder. In this case, the gate electrode GE and the upper electrode Cst2 overlapping each other with the second gate insulating layer 1113 therebetween may form the storage capacitor Cst. That is, the gate electrode GE may function as a lower electrode Cst1 of the storage capacitor Cst.

As such, in an embodiment, the storage capacitor Cst and the thin film transistor TFT may be formed to overlap each other. In some embodiments, the storage capacitor Cst may be formed not to overlap the thin film transistor TFT.

In an embodiment, the upper electrodes Cst2 may include aluminum (Al), platinum (Pt), palladium (Pd), silver (Ag), magnesium (Mg), gold (Au), nickel (Ni), neodymium (Nd), iridium (Ir), chromium (Cr), calcium (Ca), molybdenum (Mo), titanium (Ti), tungsten (W), and/or copper (Cu) and may include a single layer or multiple layers of the above material.

In an embodiment, the interlayer insulating layer 1114 may cover the upper electrode Cst2. The interlayer insulating layer 1114 may include silicon oxide (SiO₂), silicon nitride (SiNₓ), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). The zinc oxide (ZnOₓ) may include zinc oxide (ZnO) and/or zinc peroxide (ZnO₂). The interlayer insulating layer 1114 may include a single layer or multiple layers including the above inorganic insulating material.

In an embodiment, each of the drain electrode DE and the source electrode SE may be located over the interlayer insulating layer 1114. The drain electrode DE and the source electrode SE may be respectively connected to the drain area D and the source area S through contact holes formed in the insulating layers thereunder. The drain electrode DE and the source electrode SE may include a material having high conductivity. The drain electrode DE and the source electrode SE may include a conductive material including molybdenum (Mo), aluminum (Al), copper (Cu), titanium (Ti), and/or the like and may include a single layer or multiple layers including the above material. In an embodiment, the drain electrode DE and the source electrode SE may have a multilayer structure of Ti/Al/Ti.

In an embodiment, the first planarization insulating layer 1115 may cover the drain electrode DE and the source electrode SE. The first planarization insulating layer 1115 may include an organic insulating material such as a general-purpose polymer such as polymethylmethacrylate (PMMA) or polystyrene (PS), a polymer derivative having a phenolic group, an acrylic polymer, an imide-based polymer, an aryl ether-based polymer, an amide-based polymer, a fluorine-based polymer, a p-xylene-based polymer, a vinyl alcohol-based polymer, and/or any blend thereof.

In an embodiment, the second planarization insulating layer 1116 may be disposed over the first planarization insulating layer 1115. The second planarization insulating layer 1116 may include the same material as the first planarization insulating layer 1115 and may include an organic insulating material such as a general-purpose polymer such as polymethylmethacrylate (PMMA) or polystyrene (PS), a polymer derivative having a phenolic group, an acrylic polymer, an imide-based polymer, an aryl ether-based polymer, an amide-based polymer, a fluorine-based polymer, a p-xylene-based polymer, a vinyl alcohol-based polymer, and/or any blend thereof.

In an embodiment, the display element layer DEL may be disposed over the pixel circuit layer PCL having the above structure. The display element layer DEL may include an organic light emitting diode OLED as a display element (i.e., a light emitting element), and the organic light emitting diode OLED may include a stack structure of a pixel electrode 210, an intermediate layer 220, and a common electrode 230. For example, the organic light emitting diode OLED may emit red, green, or blue light or may emit red, green, blue, or white light. The organic light emitting diode OLED may emit light through an emission area, and the emission area may be defined as a pixel PX.

In an embodiment, the pixel electrode 210 of the organic light emitting diode OLED may be electrically connected to the thin film transistor TFT through contact holes formed in the second planarization insulating layer 1116 and the first planarization insulating layer 1115 and a contact metal CM disposed over the first planarization insulating layer 1115.

In an embodiment, the pixel electrode 210 may include a conductive oxide such as indium tin oxide (ITO), indium zinc oxide (IZO), zinc oxide (ZnO), indium oxide (In₂O₃), indium gallium oxide (IGO), and/or aluminum zinc oxide (AZO). In another embodiment, the pixel electrode 210 may include a reflective layer including silver (Ag), magnesium (Mg), aluminum (Al), platinum (Pt), palladium (Pd), gold (Au), nickel (Ni), neodymium (Nd), iridium (Ir), chromium (Cr), and/or any compound thereof. In another embodiment, the pixel electrode 210 may further include a layer formed of ITO, IZO, ZnO, or In₂O₃ over/under the reflective layer.

In an embodiment, a bank layer 1117 including an opening 117OP exposing a center portion of the pixel electrode 210 may be disposed over the pixel electrode 210. The bank layer 1117 may include an organic insulating material and/or an inorganic insulating material. The opening 117OP may define an emission area of light emitted from the organic light emitting diode OLED. For example, the size/width of the opening 117OP may correspond to the size/width of the emission area. Thus, the size and/or width of the pixel PX may depend on the size and/or width of the opening 117OP of the bank layer 1117 corresponding thereto.

In an embodiment, the intermediate layer 220 may include an emission layer 2222 formed to correspond to the pixel electrode 210. The emission layer 2222 may include a high-molecular or low-molecular weight organic material for emitting light of a certain color. Alternatively, the emission layer 2222 may include an inorganic light emitting material and/or may include quantum dots.

In an embodiment, the intermediate layer 220 may include a first functional layer 2221 and a second functional layer 2223 respectively disposed under and over the emission layer 2222. The first functional layer 2221 may include, for example, a hole transport layer (HTL) or may include an HTL and a hole injection layer (HIL). The second functional layer 2223 may be a component disposed over the emission layer 2222 and may include an electron transport layer (ETL) and/or an electron injection layer (EIL). Like the common electrode 230 described below, the first functional layer 2221 and/or the second functional layer 2223 may be a common layer formed to entirely cover the substrate 100.

In an embodiment, the common electrode 230 may be disposed over the pixel electrode 210 and may overlap the pixel electrode 210. The common electrode 230 may include a conductive material having a low work function. For example, the common electrode 230 may include a (semi)transparent layer including silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), and/or any alloy thereof. Alternatively, the common electrode 230 may further include a layer such as ITO, IZO, ZnO, and/or In₂O₃ over the (semi)transparent layer including the above material. The common electrode 230 may be integrally formed to entirely cover the substrate 100.

In an embodiment, the encapsulation layer 300 may be disposed over the display element layer DEL and may cover the display element layer DEL. The encapsulation layer 300 may include at least one inorganic encapsulation layer and at least one organic encapsulation layer, and in an embodiment, FIG. 6 illustrates that the encapsulation layer 300 includes a first inorganic encapsulation layer 310, an organic encapsulation layer 320, and a second inorganic encapsulation layer 330 that are sequentially stacked.

In an embodiment, the first inorganic encapsulation layer 310 and the second inorganic encapsulation layer 330 may include one or more inorganic materials among aluminum oxide, titanium oxide, tantalum oxide, hafnium oxide, zinc oxide, silicon oxide, silicon nitride, and/or silicon oxynitride. The organic encapsulation layer 320 may include a polymer-based material. The polymer-based material may include acryl-based resin, epoxy-based resin, polyimide, polyethylene, and the like. In an embodiment, the organic encapsulation layer 320 may include acrylate. The organic encapsulation layer 320 may be formed by curing a monomer or applying a polymer. The organic encapsulation layer 320 may be transparent.

Although not illustrated, in an embodiment, a touch sensor layer may be disposed over the encapsulation layer 300, and an optical functional layer may be disposed over the touch sensor layer. The touch sensor layer may be configured to obtain coordinate information according to an external input, for example, a touch event. The optical functional layer may reduce the reflectance of light (external light) incident from the outside toward the display apparatus and/or may improve the color purity of light emitted from the display apparatus. In an embodiment, the optical functional layer may include a phase retarder and/or a polarizer. The phase retarder may be a film type or a liquid crystal coating type and may include a λ/2 phase retarder and/or a λ/4 phase retarder. The polarizer may also be a film type or a liquid crystal coating type. The film type may include a stretched synthetic resin film, and the liquid crystal coating type may include liquid crystals arranged in a certain arrangement. The phase retarder and the polarizer may further include a protection film.

In an embodiment, an adhesive member may be arranged between the touch electrode layer and the optical functional layer. The adhesive member may include a general one known in the art, without limitation. The adhesive member may include a pressure sensitive adhesive (PSA).

In an embodiment, at least one of the first processed product GD1 and the second processed product GD21 described above with reference to FIGS. 1 to 3 may include at least one of the substrate 100, the pixel circuit layer PCL, the display element layer DEL, and the encapsulation layer 300.

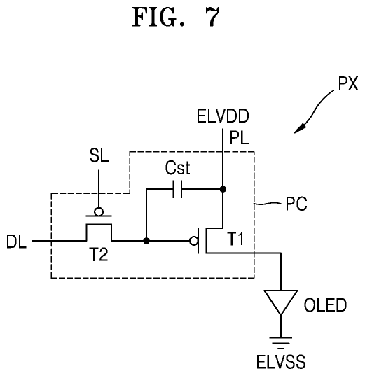

FIG. 7 is an equivalent circuit diagram of a pixel of a display panel, according to an embodiment.

In an embodiment and referring to FIG. 7, each pixel PX may include a pixel circuit PC and a display element, for example, an organic light emitting diode OLED, connected to the pixel circuit PC. The pixel circuit PC may include a first thin film transistor T1, a second thin film transistor T2, and a storage capacitor Cst. Each pixel PX may emit, for example, red, green, blue, or white light from the organic light emitting diode OLED.

In an embodiment, as a switching thin film transistor, the second thin film transistor T2 may be connected to a scan line SL and a data line DL and may be configured to transmit a data voltage input from the data line DL to the first thin film transistor T1, based on a switching voltage input from the scan line SL. The storage capacitor Cst may be connected to the second thin film transistor T2 and a driving voltage line PL and may be configured to store a voltage corresponding to the difference between a voltage received from the second thin film transistor T2 and a first power voltage ELVDD supplied to the driving voltage line PL.

In an embodiment, as a driving thin film transistor, the first thin film transistor T1 may be connected to the driving voltage line PL and the storage capacitor Cst and may be configured to control a driving current flowing from the driving voltage line PL through the organic light emitting diode OLED in response to a voltage value stored in the storage capacitor Cst. The organic light emitting diode OLED may emit light with a certain brightness according to the driving current. An opposite electrode (e.g., a cathode) of the organic light emitting diode OLED may be supplied with a second power voltage ELVSS.

FIG. 7 illustrates that the pixel circuit PC includes two thin film transistors and one storage capacitor according to an embodiment. However, the invention is not limited thereto. The number of thin film transistors and the number of storage capacitors may be variously modified according to the design of the pixel circuit PC. For example, the pixel circuit PC may further include four or more thin film transistors in addition to the two thin film transistors described above.

In an embodiment, the display apparatus manufacturing apparatus 1 and the method according to embodiments may reduce possible defects during the manufacture of the display apparatus. Also, the display apparatus manufacturing apparatus 1 and the method according to embodiments may optimize the display apparatus manufacturing process. The display apparatus manufacturing apparatus 1 and method according to embodiments may diagnose a possible error in the process thereof at an early stage and notify the same to the user.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims. The embodiments disclosed in the present disclosure and illustrated in the drawings are provided as particular examples for more easily explaining the technical contents according to the invention and helping understand the embodiments, but not intended to limit the scope of the embodiments. Accordingly, the scope of the various embodiments should be interpreted to include, in addition to the embodiments disclosed herein, all alterations or modifications derived from the technical ideas of the various embodiments. Moreover, the embodiments or parts of the embodiments may be combined in whole or in part without departing from the scope of the invention.

What is claimed is:

1. An apparatus for manufacturing a display apparatus, the apparatus comprising:
a first process line comprising a plurality of first processors configured to process a plurality of first processed products, wherein each of the plurality of first processors comprise a plurality of first parts;
a second process line comprising a plurality of second processors configured to process each of the plurality of first processed products processed by the first processor into a second processed product, wherein each of the plurality of second processors comprise a plurality of second parts; and
a controller configured to receive data generated from each of the plurality of first parts and each of the plurality of second parts and generate a work schedule of at least one of the first process line and the second process line based on the data,
wherein the controller is further configured to select at least one of the plurality of first parts and the plurality of second parts affecting a defect of the second processed product as a monitoring part based on whether there is a defect in the second processed product, and when a defect occurs in the second processed product, to calculate a data threshold of the monitoring part, compare monitoring data of the monitoring part with the data threshold, and modify a work schedule of at least one of the first process line and the second process line.

2. The apparatus of claim 1, wherein the controller is further configured to simulate modification of the work schedule of at least one of a first process line and a second process line in a digital twin.

3. The apparatus of claim 1, wherein the controller is further configured to calculate an action time necessary for replacing the monitoring part when the monitoring data of the monitoring part is greater than or equal to a certain percentage of the data threshold.

4. The apparatus of claim 3, wherein the controller is further configured to calculate a runnable time of the second processor, wherein the runnable time of the second processor is different from a stopped time of the second processor that is stopped during the action time.

5. The apparatus of claim 4, wherein the controller is further configured to compare the runnable time with the action time, and when the runnable time is greater than or equal to the action time, exclude the second processor that is stopped from the work schedule and perform the modification of the work schedule such that the second processor operates differently from how the second processor that is stopped operates.

6. The apparatus of claim 3, wherein the controller is further configured to compare the runnable time with the action time and modify the work schedule of the first process line when the runnable time is less than the action time.

7. The apparatus of claim 1, wherein the controller is further configured to transmit, to a worker, an operation image of the monitoring part and at least one of the first processor and the second processor, including the monitoring part implemented as a digital twin when the monitoring data of the monitoring part is greater than or equal to the data threshold and an operation image of the monitoring part and at least one of the first processor and the second processor including the monitoring part implemented as a digital twin when the monitoring data of the monitoring part is less than the data threshold.

8. The apparatus of claim 3, wherein the certain percentage is about 90%.

9. The apparatus of claim 1, wherein the controller comprises a simulator configured to perform a simulation.

10. A method of manufacturing a display apparatus, the method comprising:
collecting process data generated from a plurality of parts for each of a plurality of processors during manufacture of a product;
inputting the collected process data to a digital twin and then comparing, among the collected process data, first process data for each of the plurality of parts collected when a defect occurs in the product with second process data for each of the plurality of parts collected when a defect does not occur in the product and determining a monitoring part affecting the first process data and a defect of the product among the plurality of parts and a first data threshold of the monitoring part;
collecting monitoring data sensed from the monitoring part; and
comparing the monitoring data with the first data threshold and determining whether the monitoring data and the first data threshold are different from each other.

11. The method of claim 10, further comprising stopping an operation of a processor comprising the monitoring part when the monitoring data exceeds a certain percentage of the first data threshold.

12. The method of claim 11, wherein the certain percentage is about 90%.

13. The method of claim 11, further comprising calculating an action time for stopping the operation of the processor comprising the monitoring part in order to replace the monitoring part.

14. The method of claim 13, further comprising determining whether there is a runnable processor among the plurality of processors during the action time.

15. The method of claim 14, further comprising, when it is determined that there is a runnable processor, calculating a runnable time of the runnable processor in the digital twin.

16. The method of claim 15, further comprising running the runnable processor that is different from the processor comprising the monitoring part, when the runnable time is greater than the action time.

17. The method of claim 15, further comprising stopping an operation of at least one of the plurality of processors when the runnable time is less than the action time.

18. The method of claim 17, wherein the plurality of processors comprise:
a plurality of first processors configured to perform a first process;
a storage, wherein the storage receives and stores a first processed product processed by each of the plurality of first processors;
a plurality of second processors configured to generate a second processed product by performing a second process on the first processed product stored in the storage, and
controlling an operation of the first processor based on a filling rate of the storage when the runnable time is less than the action time.

19. The method of claim 10, further comprising comparing and displaying an image of the monitoring part in a state of the first data threshold and an image of the monitoring part in a state other than the state of the first data threshold.

20. The method of claim 10, further comprising generating a work schedule by comparing the monitoring data with the first data threshold.
